(19) United States
(12) Patent Application Publication
(10) Pub. No.: US 2009/0150907 A1
(43) Pub. Date: Jun. 11, 2009

(54) MAPPING BETWEEN DISPARATE DATA MODELS VIA ANONYMOUS FUNCTIONS

(75) Inventors: Avner Y. Aharoni, Seattle, WA (US); Erik Meijer, Mercer Island, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/952,281

(22) Filed: Dec. 7, 2007

(51) Int. Cl. G06F 3/00

(52) U.S. Cl. 719/318

(57) ABSTRACT

Systems and methods that transform an input stream to an output stream by employing a hybrid of declarative features and procedural features. A transformation component includes a declaration component that identifies data types, which enables users to define customized event(s) whereupon user functions can be called, and a procedural component that executes the logic of the functions that are called to perform operations of the functions.

### BACKGROUND

Technology advancements and cost reductions over time have enabled computers to become commonplace in society. Enterprises employ computers to collect and analyze data. For instance, computers are often employed to capture data about business customers that can be utilized to track sales and/or customer demographics. Further yet, individuals also interact with a plurality of non-enterprise computing devices including home computers, laptops, personal digital assistants, digital video and picture cameras, mobile devices, and the like. Accordingly, both enterprises and individuals generate an enormous quantity of digital data.

In such environments, a data model plays an important role in the design of applications that interact with storage mediums and databases. The manner in which an application stores and retrieves data is collectively known as the application's data model. In general, the term “data model” can refer to: the abstract description how data elements are represented and/or how those elements are related to each other, and/or even the physical instantiation of those representations in bits in memory or on permanent storage.

Nonetheless, data existing in one format is often needed in a different format for another purpose. These requirements are hampered by a largely disparate and ever-changing set of datasets. For example, in data warehousing data is received from many different sources for storage and quick access from other sources. Converting from one data representation to another is not only time-consuming and resource intensive, but can also be fraught with conversion problems, and in some cases, totally impracticable due to the complexity.

Conventional mapping that is performed by generalized component between disparate data models is typically done by mapping a type in one data model to the applicable type in the other data model. The application that performs the transformation obtains metadata and mapping information about each data model, to perform the transformation. In general, this approach has limitations that stems from limited expressiveness of type based mapping languages.

Moreover, mapping language can become more complex when additional constructs have been added to increase expressiveness and provide ways to change the mapping operation based on information that is known while the program runs.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject innovation transforms an input stream to an output stream by employing a hybrid of declarative features and procedural features, via a transformation component. The transformation component includes a declaration component that identifies data types that enables users to define customized event(s) whereupon user functions can be called. Moreover, the transformation component further includes a procedural component that executes logic of the functions that are called and performs operations of the functions. Such an arrangement enables generalized processing for input/output of the mapping application, and for customized programs of the users to perform the actual mapping transformation on the instance data as it is being processed in by the generalized component pipeline. For example, mapping can be performed by having the user write function (for each table) that takes in XElement and return 0 or more rows (either object array or possibly typed rows of dataset). The API can subsequently manage advancing through the XML stream, calling such functions for each element and inserting the result to the appropriate tables. The order of insertion is based on the hierarchy of the Xml document.

Accordingly, events defined by users (e.g., events of interests described by predicates) can be associated with computations, wherein events of interest can be declaratively specified on an input stream of the transformation component. In a related aspect, the declarative component can be in form of a scheduling component that identifies a predetermined event that are type based, and can further call the functions associated with the scheduling component. Hence, data streams can be processed to identify instances that are categorized as data types, wherein mapping can then occur based on types encountered. For example, an actual transformation function that is instance based can be defined per type by a user. The scheduling component calls events or data that satisfy configured predicates, to create the output stream. Moreover, such configuration can adapt its behavior based on a plurality of intelligent machine learning schemas. As such, a user can perform mapping in the code (rather than declare it), wherein the user can also look for values in the program, in the database—in addition to the current Xml element in the stream, for example.

In a related methodology, a data source input is initially received via a streaming interface. For such data input users can identify interesting events (e.g., elements as part of an XML), which are connected to function calls. Upon occurrence of such events, the functions can then be executed to transform one data structure to another type. The events can indicate points of stop or halt in the data stream, wherein individual transformations can connect event handlers to events and specify what codes are to be executed. As such, predetermined mapping functions can be called upon encountering events in the data stream. Such mapping functions can further be adaptively trained.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 illustrates a block diagram of a transformation component that operates on a data stream(s) with different data types for a transformation thereof to another data type.

FIG. 2 illustrates an exemplary transformation component that includes a declaration component and a procedural component.

FIG. 3 illustrates a particular aspect of a transformation component in accordance with an aspect of the subject innovation.

FIG. 4 illustrates a methodology of transforming a data stream with one data type to another data type in accordance with an aspect of the subject innovation.

FIG. 5 illustrates a related methodology of performing a mapping code and transformation according to a further aspect of the subject innovation.

FIG. 6 illustrates Application Programming Interface (API) for a scheduling component in accordance with a particular aspect of the subject innovation.

FIG. 7 illustrates a use-case example for a transformation of a data stream in accordance with an aspect of the subject innovation.

FIG. 8 illustrates a data base diagram for a data stream in accordance with a further aspect of the subject innovation.

FIG. 9 illustrates a code that can be written to obtain XML data loaded to a destination.

FIG. 10 illustrates a transformation component that interacts with an artificial intelligence component in accordance with the subject innovation.

FIG. 11 illustrates a schematic block diagram of a suitable operating environment for implementing aspects of the subject innovation.

FIG. 12 illustrates a further schematic block diagram of a sample-computing environment for the subject innovation.

### DETAILED DESCRIPTION

The various aspects of the subject innovation are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

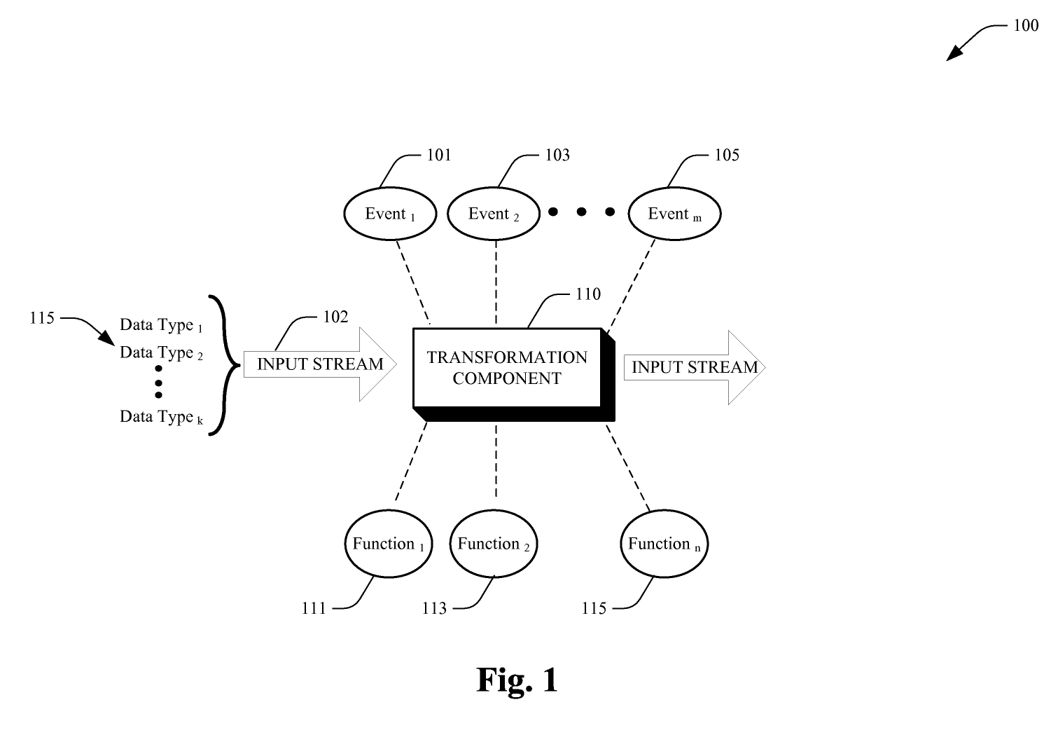

FIG. 1 illustrates a block diagram of a transformation component that operates on a plurality of data streams with different data types 115 (1 to k, where k is an integer) for a transformation thereof to another data type. Such data types 115 can be defined by a class, such as, methods, properties, fields and/or can include different facets. For example, data types can include two facets: a data facet, which includes the names and types of the fields implemented by the data type, and a behavior facet, which includes the methods and interfaces implemented by the data type. As another example, when a client interacts with a server, the interaction between the client and server may depend on a data type. Thus, the client may employ the behavior facet of the server data type. When a client invokes a method on the server, the client employs the behavior facet exposed by the server data type.

Moreover, the data types associated with the input stream can be incrementally extensible. In distributed object systems, where a common type system can be employed, associated data types are represented by objects. Thus, data types can include data aspects (e.g., attributes, fields, properties), behavior aspects (e.g., methods) and metadata (e.g., data describing the data type). Additionally, metadata associated with the data types can contain information, such as a list of attributes in a data type associated with the metadata (where the list includes attribute names, types, sizes, and the like), a list of methods in a data type associated with the metadata (where the list includes method names, parameter types, parameter sizes, method sizes, method entry addresses, and the like), a list of interfaces implemented by a data type (where an interface may include one or more methods) and information identifying one or more classes that can be employed to interact with the data type if the entity with which an interaction is desired does not have the definition of the data type (e.g., a parent class) available. While the metadata information is described above in terms of a list, it is to be appreciated that other data structures may be employed in accordance with an aspect of the present invention. For example, data structures including, but not limited to, an array, a list, a heap, a stack, a table, a database record, a database table, a database and a data cube may be employed in accordance with the present invention. The information identifying one or more classes for defining with the data type can be employed to determine whether a first data type is related to (e.g., is derived from, inherits from, is in the same inheritance tree as) a second data type.

The transformation component 110 is associated with events 101, 103, 105 (1 to m, where m is an integer), wherein such events can be defined by users. Moreover, function 111, 113, 115 (1 to n, where n is an integer) can be associated with the events 101, 103, 105 of transformation component 110, wherein such functions can be called by the transformation component upon occurrence of events 101, 103, 105. Accordingly, events 101, 103, 105 defined by users (e.g., events of interests described by predicates) can be associated with computations, wherein events of interest can be declaratively specified on the input stream 102 of the transformation component 110.

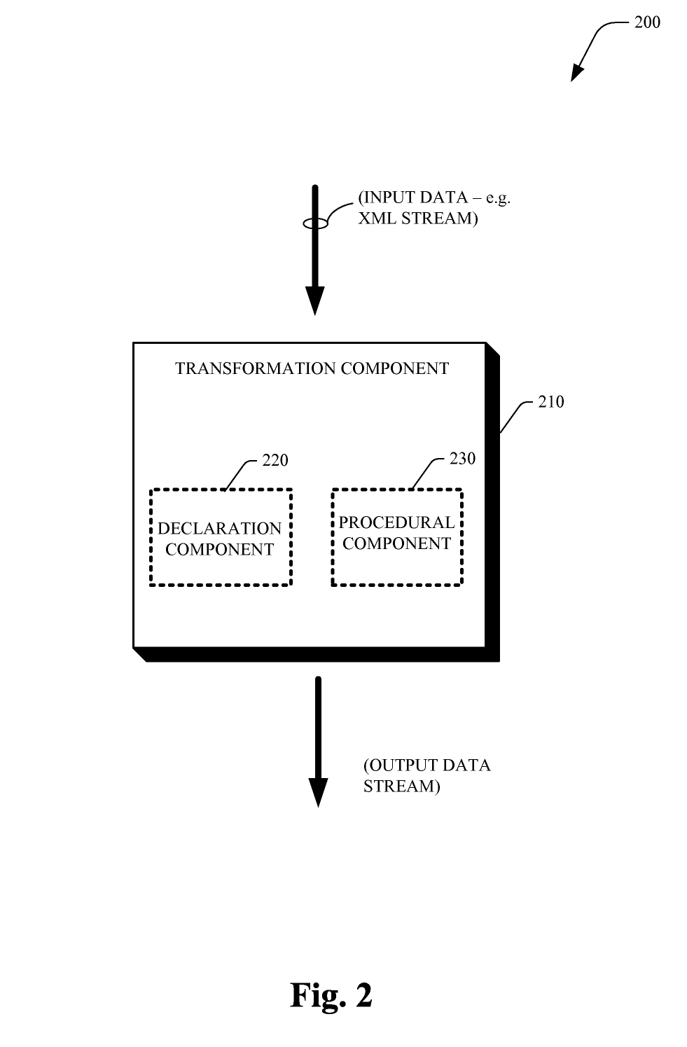

FIG. 2 illustrates a transformation component 210 that includes a declaration component 220 that identifies data types, which enable users to define customized event(s) whereupon user functions can be called. The transformation component 210 further includes a procedural component 230 that executes the logic of the functions being called, and performs the operations of the functions. Such an arrangement enables generalized processing for the input and the output of the mapping application, and for customized programs of the users to perform the actual mapping transformation on the instance data as it is being processed in by the generalized component pipeline.

For example, mapping can be performed by having the user write function (for each table) that takes in XElement and return 0 or more rows (either object array or possibly typed rows of dataset). The API can subsequently manage advancing through the XML stream, calling such functions for each element and inserting the result to the appropriate tables. The order of insertion is based on the hierarchy of the Xml document. The transformation component 210 can examine the input data stream and its related metadata to determine whether the predefined events are being encountered. For example, one or more subsystems such as a metadata reader, and attribute identifying/comparing subsystem, a method identifying/comparing subsystem (not shown) can facilitate identification of instances that are categorized as data types, wherein mapping can then occur based on types encountered.

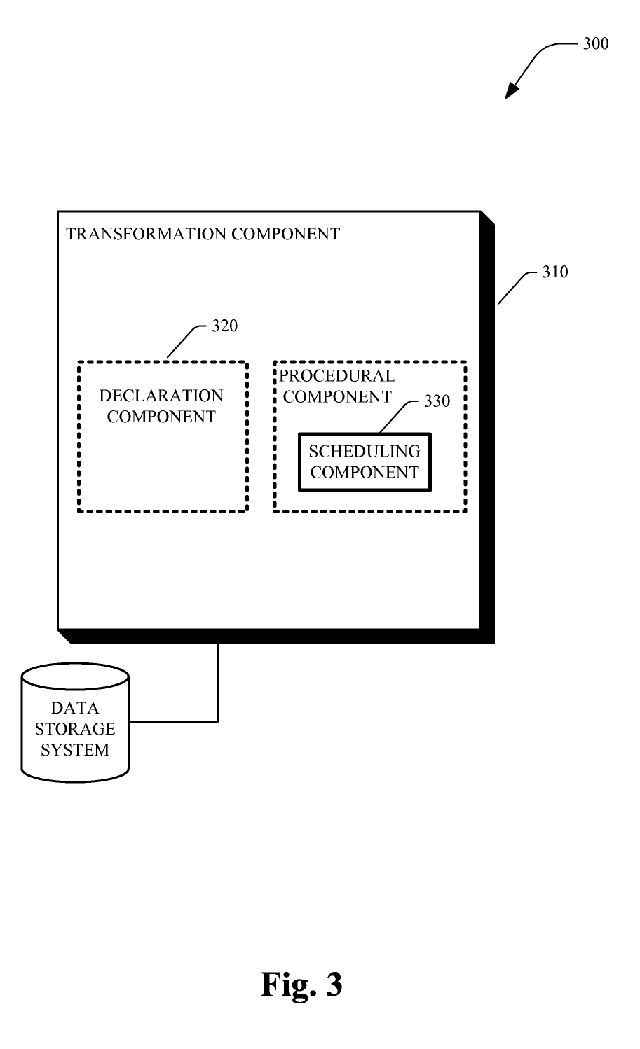

FIG. 3 illustrates a particular aspect of a transformation component 310 in accordance with an aspect of the subject innovation. The transformation component 310 includes a scheduling component 330, wherein the declarative component 310 incorporates such scheduling component—which identifies predetermined events that are type based—to further call the functions associated with the scheduling component 330. Hence, data streams can be processed to identify instances that are categorized as data types, wherein mapping can then occur based on types encountered. For example, an actual transformation function that is instance based can be defined per type by a user. The scheduling component 330 calls events or data that satisfy configured predicates, to create the output stream. Moreover, such configuration can adapt its behavior based on a plurality of intelligent machine learning schemas. As such, a user can perform mapping in the code (rather than declare it), wherein the user can also look for values in the program, in the database—in addition to the current Xml element in the stream, for example.

It is to be appreciated that, object, object instance, UI, relational tables, schema, and other constructs can be transformed to and from one another, including disparate forms of the same construct (e.g., from one object construct to another object construct). In addition, in other instances, an iterative approach can be employed, wherein a resultant construct can be cycled through the transformation component 310 multiple times until the desired construct is generated. For example, a first construct can be identified and conveyed to the transformation component 310 by the input component (not shown), wherein the transformation component 310 transforms the first construct to a second construct. The second construct can be cycled back to the transformation component 310 and transformed to a third construct. The cycle can continue until a desired construct is generated, wherein any intermediate construct as well as the desired construct can be serially and/or concurrently output by the output component (not shown).

The transformation component 310 can further include a mapping file(s) (e.g., mapping schema) that defines the mapping from construct to construct. Such mapping file(s) can comprise a default mapping, a user defined mapping, and/or a mapping based on a heuristic, an inference, machine learning and/or a probability. The mapping file(s) can be pre-determined and/or dynamically generated and/or updated. For example, a history can be maintained and employed to update inferences and probabilities and refine machine learning by employing the history as training data. As such, rather than declaring the code a user can perform mapping in the code to identify values in the input stream, for example.

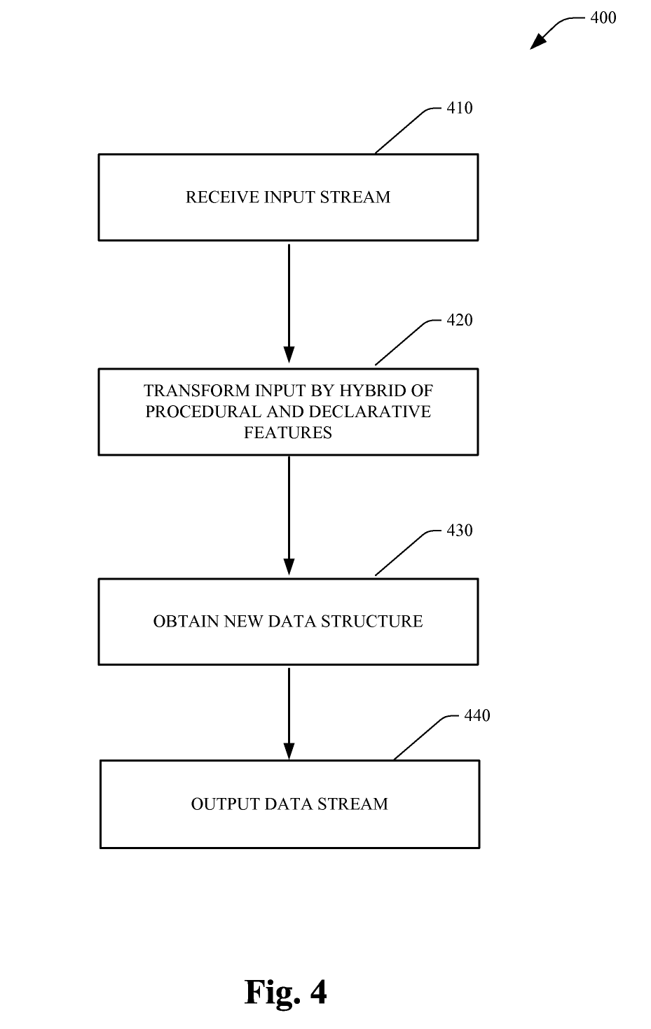

FIG. 4 illustrates a methodology 400 of transforming a data stream with one data type to another data type in accordance with an aspect of the subject innovation. While the exemplary method is illustrated and described herein as a series of blocks representative of various events and/or acts, the subject innovation is not limited by the illustrated ordering of such blocks. For instance, some acts or events may occur in different orders and/or concurrently with other acts or events, apart from the ordering illustrated herein, in accordance with the innovation. In addition, not all illustrated blocks, events or acts, may be required to implement a methodology in accordance with the subject innovation. Moreover, it will be appreciated that the exemplary method and other methods according to the innovation may be implemented in association with the method illustrated and described herein, as well as in association with other systems and apparatus not illustrated or described. Initially, and at 410 an input data can be received by the transformation component for change of a data type to another data type. Next and at 420, such input data stream can be transformed by hybrid of procedural and declarative features. This enables generalized processing for the input and the output of the mapping application, and for customized programs of the users to perform the actual mapping transformation on the instance data as it is being processed in by the generalized component pipeline. At 430 new data structure can be obtained that can be implemented as part of the output data stream at 440.

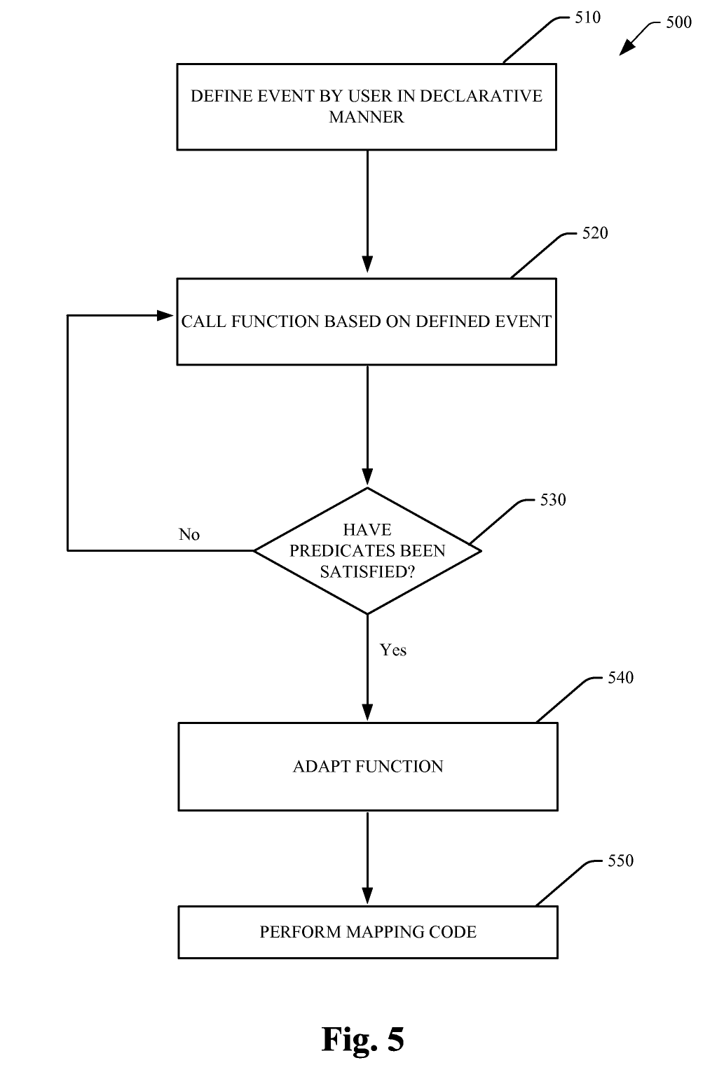

FIG. 5 illustrates a related methodology 500 of performing a mapping code and transformation according to a further aspect of the subject innovation. Initially and at 510, a plurality of events (e.g., events of interests described by predicates) can be defined by a user, in a declarative manner. The events can indicate points of stop in the data stream, wherein individual transformations can be connect event handlers to events and specify what codes are to be executed. Such predetermined events can be type based, and can call functions based on defined event at 520. Next and at 530, a determination is made whether predicates have been satisfied—wherein data streams can be processed to identify instances that are categorized as data types. If the predicates have been satisfied, and at 540, configuration for predicates can adapt its behavior based on a plurality of intelligent machine learning schemas. Accordingly, a user can perform mapping in the code (rather than declare it), wherein the user can also look for values in the program, in the database—in addition to the current Xml element in the stream, for example.

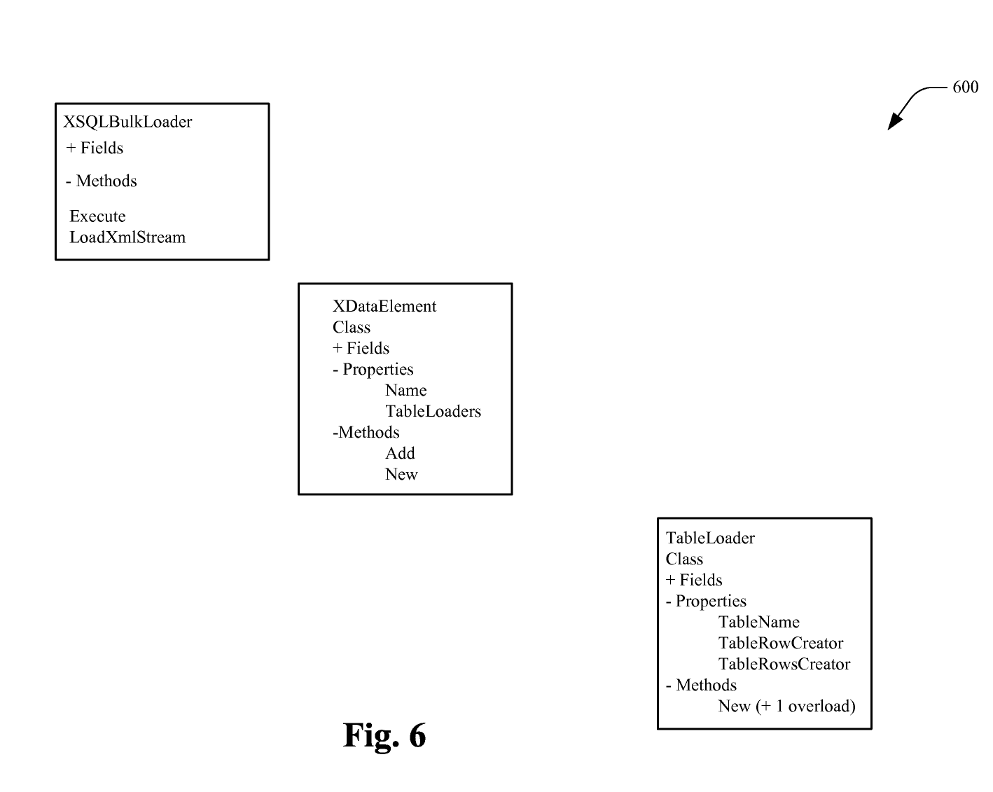

FIG. 6 illustrates an Application Programming Interface (API) for a scheduling component in accordance with an aspect of the subject innovation. The API stream 600 of the subject innovation manages scheduling of data streams. Such exemplary API enables users to perform instance based mapping between Xml and relational data that can further scales to any document size. The API can also perform the actual shredding of an input Xml stream and the insertion of the resulting rows into the destination tables in the database. Moreover, the API is fully streaming thus provides scalability and performance. The subject innovation enables users to perform the mapping in the code rather than declare it. The following are acts required to shred Xml document to relational database: initially, an XDataElement can be created for each Xml element in the path from the root element to the lowest element that the user requires the stream to stop at. The stream can stop at each element along such path. Next, a table loader for each table can be created. Such table loader includes a table name and a function that takes in XElement and returns 0 or more object arrays (each object array represent a row). The appropriate table loaders can then be added to the applicable XDataElements created in the prior act. Subsequently, XSQLBulkload can be created that take in Xml stream or file name, SQL Connection and array of XDataElements. Next, the Execute( ) method can be called.

Moreover, the implementation consists of two additional private classes that implements IDataReader interface, and also employs the SQLBulkCopy class. The first class can be referred to as XDataReader, wherein such class implements IDataReader and manages the XML stream, stopping in the right elements and writing the row in the stream to the database. Such order of writing can be based on the hierarchy of the Xml and the order of functions that are associated with the Xml elements. The second class is XDataRowReader and this class exposes IDataReader for one row at a time.

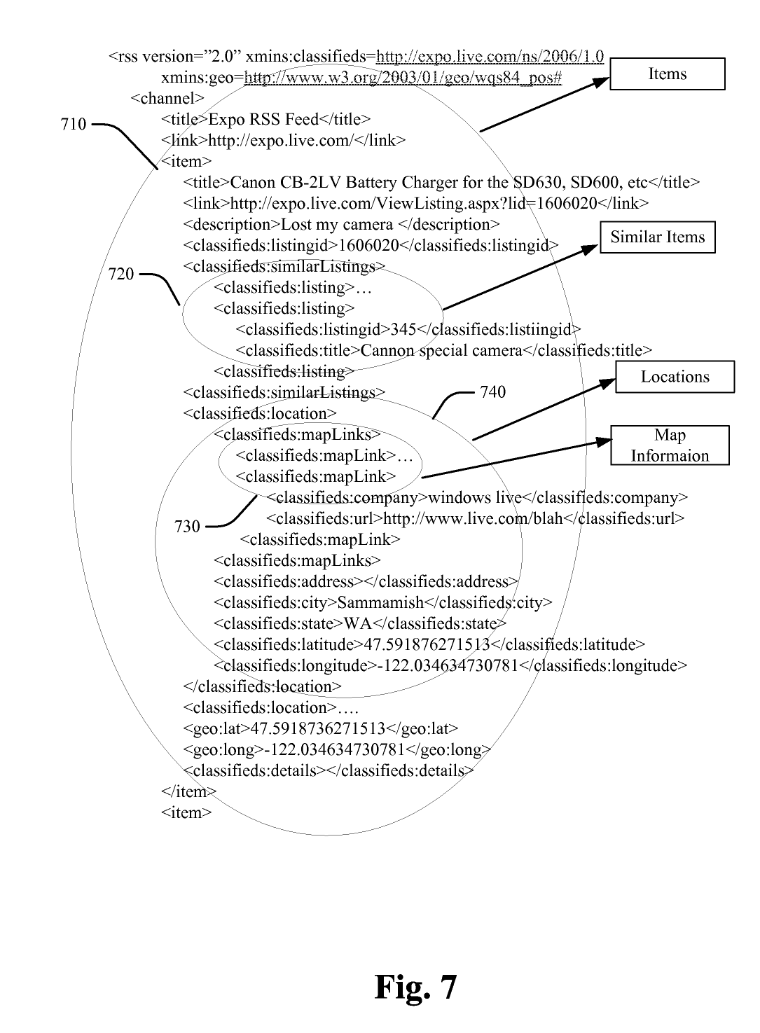

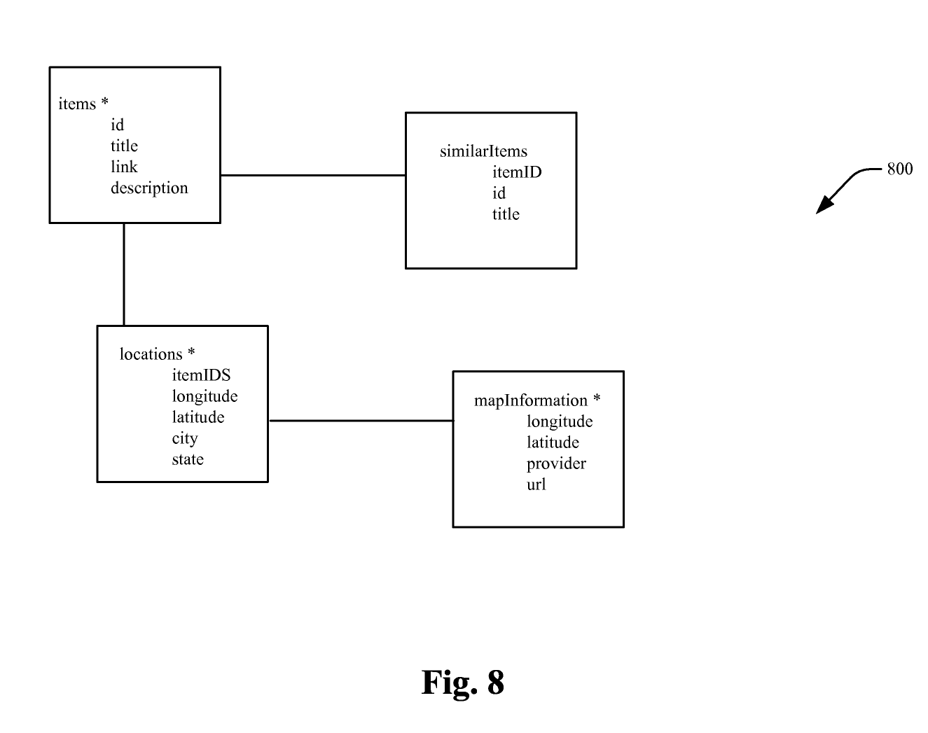

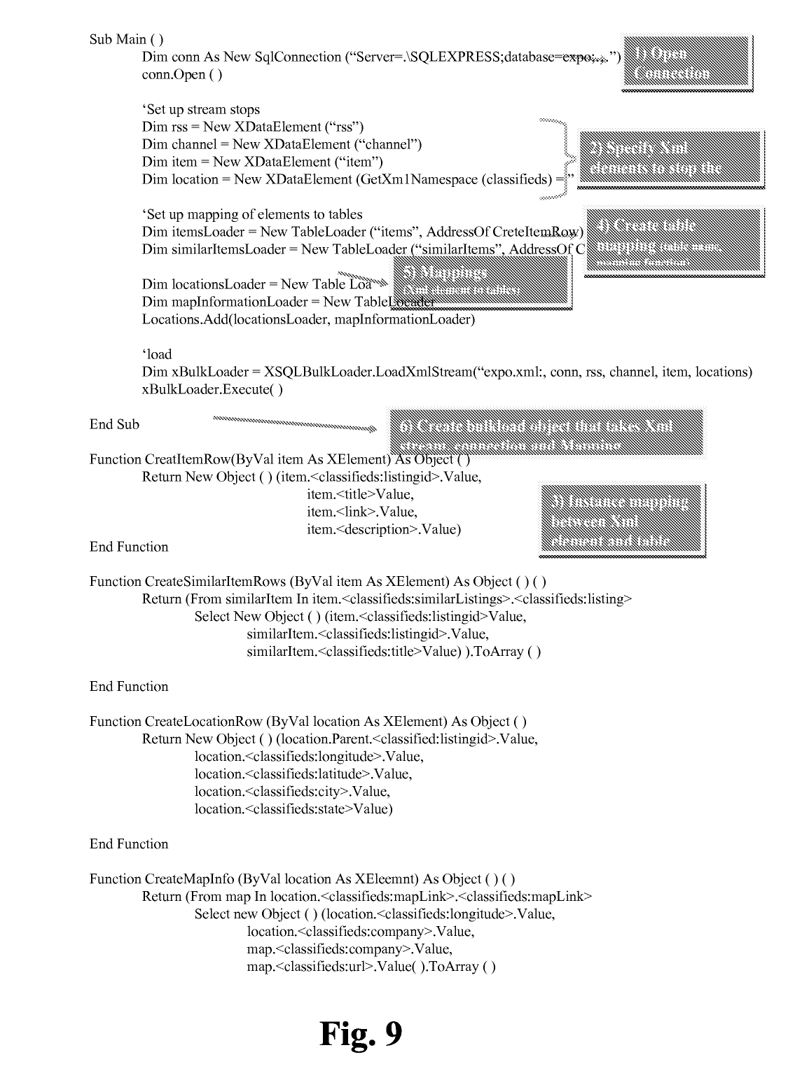

FIG. 7 & FIG. 8 illustrate a use-case example for transformation of a data stream and an associated database diagram 800 in accordance with an aspect of the subject innovation. Such transforms XML input data stream into a relational storage, wherein the various circles 710, 720, 730, 740 illustrate a mapping between the input and the output—e.g., the circle 710 represents an item type in the XML. Likewise, FIG. 9 illustrates a code that can be written to obtain the Xml data loaded to the destination tables of FIG. 7, which illustrates the simplicity and efficiency of the mapping for the subject innovation.

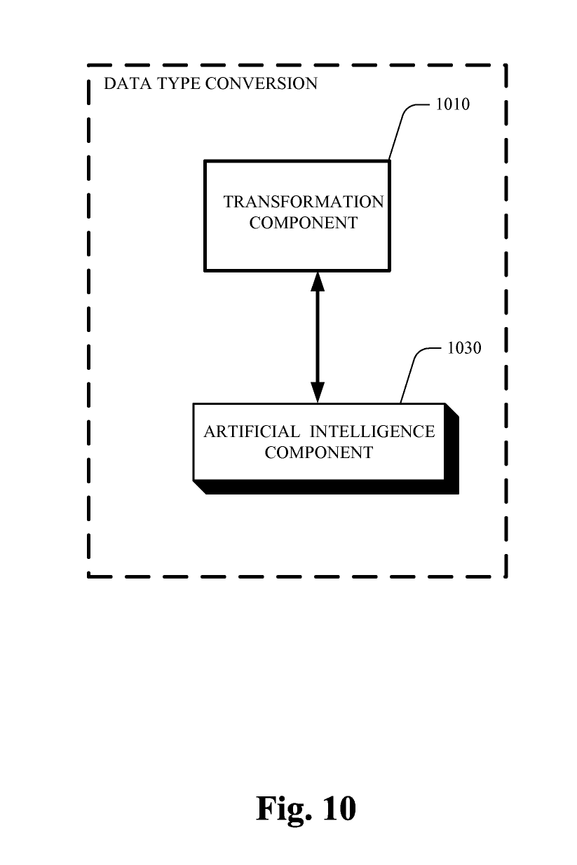

FIG. 10 illustrates a transformation component 1010 that can interact with an artificial intelligence component 1030, which facilitates where, how, and when to call functions in accordance with an aspect of the subject innovation. As used herein, the term “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

The AI component 1030 can employ any of a variety of suitable AI-based schemes as described supra in connection with facilitating various aspects of the herein described invention. For example, a process for learning explicitly or implicitly how or which function to call and/or which rule to employ can be facilitated via an automatic classification system and process. Classification can employ a probabilistic and/or statistical-based analysis (e.g., factoring into the analysis utilities and costs) to prognose or infer an action that a user desires to be automatically performed. For example, a support vector machine (SVM) classifier can be employed. Other classification approaches include Bayesian networks, decision trees, and probabilistic classification models providing different patterns of independence can be employed. Classification as used herein also is inclusive of statistical regression that is utilized to develop models of priority.

As will be readily appreciated from the subject specification, the subject innovation can employ classifiers that are explicitly trained (e.g., via a generic training data) as well as implicitly trained (e.g., via observing user behavior, receiving extrinsic information) so that the classifier is used to automatically determine according to a predetermined criteria which answer to return to a question. For example, with respect to SVM's that are well understood, SVM's are configured via a learning or training phase within a classifier constructor and feature selection module. A classifier is a function that maps an input attribute vector, x=(x1, x2, x3, x4, xn), to a confidence that the input belongs to a class—that is, f(x)=confidence(class).

As used in herein, the terms “component,” “system” and the like are intended to refer to a computer-related entity, either hardware, a combination of hardware and software, software or software in execution. For example, a component can be, but is not limited to being, a process running on a processor, a processor, an object, an instance, an executable, a thread of execution, a program and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Similarly, examples are provided herein solely for purposes of clarity and understanding and are not meant to limit the subject innovation or portion thereof in any manner. It is to be appreciated that a myriad of additional or alternate examples could have been presented, but have been omitted for purposes of brevity.

Furthermore, all or portions of the subject innovation can be implemented as a system, method, apparatus, or article of manufacture using standard programming and/or engineering techniques to produce software, firmware, hardware or any combination thereof to control a computer to implement the disclosed innovation. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

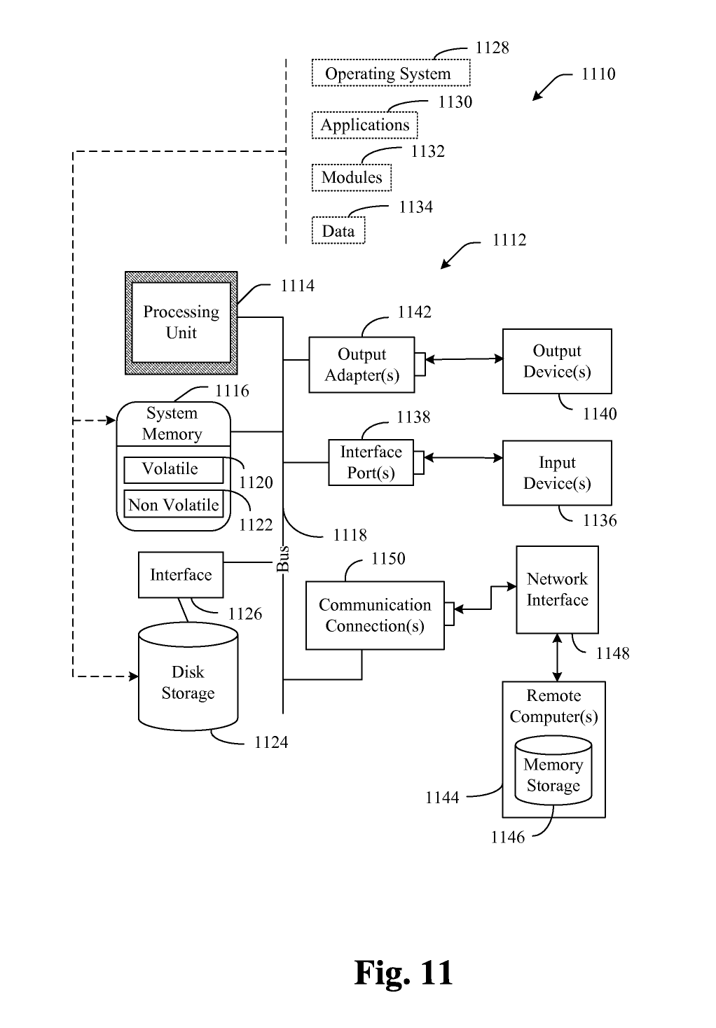

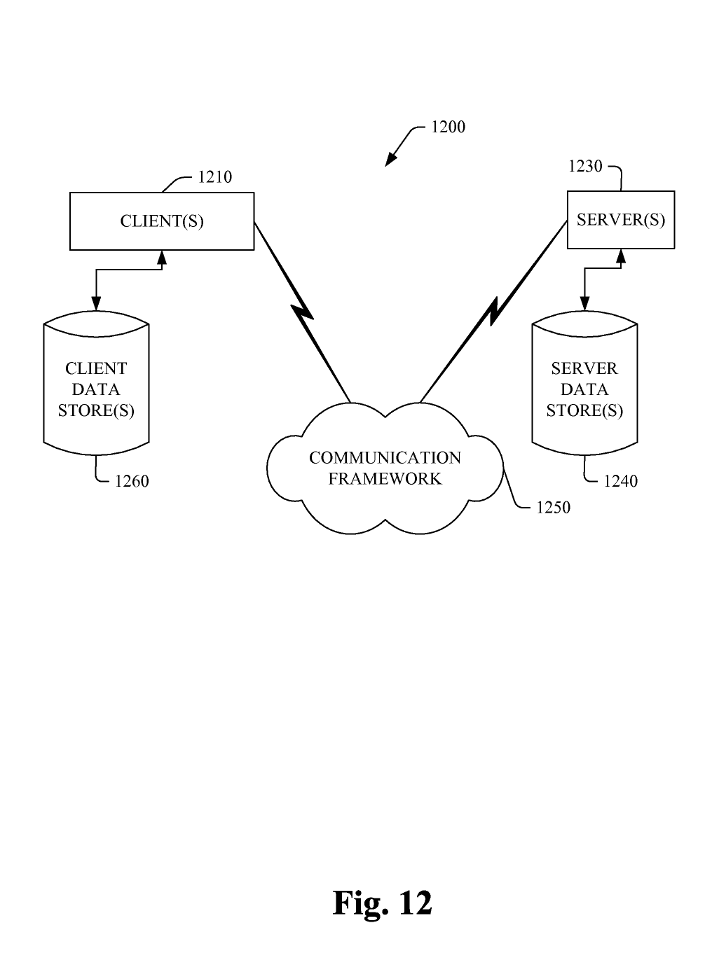

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a computer program that runs on a computer and/or computers, those skilled in the art will recognize that the innovation also may be implemented in combination with other program modules. Generally, program modules include routines, programs, components, data structures, and the like, which perform particular tasks and/or implement particular abstract data types. Moreover, those skilled in the art will appreciate that the innovative methods can be practiced with other computer system configurations, including single-processor or multiprocessor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the innovation can be practiced on stand-alone computers. In a distributed computing environment, program modules may be located in both local and remote memory storage devices.

With reference to FIG. 11, an exemplary environment 1110 for implementing various aspects of the subject innovation is described that includes a computer 1112. The computer 1112 includes a processing unit 1114, a system memory 1116, and a system bus 1118. The system bus 1118 couples system components including, but not limited to, the system memory 1116 to the processing unit 1114. The processing unit 1114 can be any of various available processors. Dual microprocessors and other multiprocessor architectures also can be employed as the processing unit 1114.

The system bus 1118 can be any of several types of bus structure(s) including the memory bus or memory controller, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 1116 includes volatile memory 1120 and nonvolatile memory 1122. The basic input/output system (BIOS), containing the basic routines to transfer information between elements within the computer 1112, such as during start-up, is stored in nonvolatile memory 1122. By way of illustration, and not limitation, nonvolatile memory 1122 can include read only memory (ROM), programmable ROM (PROM), electrically programmable ROM (EPROM), electrically erasable ROM (EEPROM), or flash memory. Volatile memory 1120 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 1112 also includes removable/non-removable, volatile/non-volatile computer storage media. FIG. 11 illustrates a disk storage 1124, wherein such disk storage 1124 includes, but is not limited to, devices like a magnetic disk drive, floppy disk drive, tape drive, Jaz drive, Zip drive, LS-60 drive, flash memory card, or memory stick. In addition, disk storage 1124 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1124 to the system bus 1118, a removable or non-removable interface is typically used such as interface 1126.

It is to be appreciated that FIG. 11 describes software that acts as an intermediary between users and the basic computer resources described in suitable operating environment 1110. Such software includes an operating system 1128. Operating system 1128, which can be stored on disk storage 1124, acts to control and allocate resources of the computer system 1112. System applications 1130 take advantage of the management of resources by operating system 1128 through program modules 1132 and program data 1134 stored either in system memory 1116 or on disk storage 1124. It is to be appreciated that various components described herein can be implemented with various operating systems or combinations of operating systems.

A user enters commands or information into the computer 1112 through input device(s) 1136. Input devices 1136 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1114 through the system bus 1118 via interface port(s) 1138. Interface port(s) 1138 include, for example, a serial port, a parallel port, a game port, and a universal serial bus (USB). Output device(s) 1140 use some of the same type of ports as input device(s) 1136. Thus, for example, a USB port may be used to provide input to computer 1112, and to output information from computer 1112 to an output device 1140. Output adapter 1142 is provided to illustrate that there are some output devices 1140 like monitors, speakers, and printers, among other output devices 1140 that require special adapters. The output adapters 1142 include, by way of illustration and not limitation, video and sound cards that provide a means of connection between the output device 1140 and the system bus 1118. It should be noted that other devices and/or systems of devices provide both input and output capabilities such as remote computer(s) 1144.

Computer 1112 can operate in a networked environment using logical connections to one or more remote computers, such as remote computer(s) 1144. The remote computer(s) 1144 can be a personal computer, a server, a router, a network PC, a workstation, a microprocessor based appliance, a peer device or other common network node and the like, and typically includes many or all of the elements described relative to computer 1112. For purposes of brevity, only a memory storage device 1146 is illustrated with remote computer(s) 1144. Remote computer(s) 1144 is logically connected to computer 1112 through a network interface 1148 and then physically connected via communication connection 1150. Network interface 1148 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1150 refers to the hardware/software employed to connect the network interface 1148 to the bus 1118. While communication connection 1150 is shown for illustrative clarity inside computer 1112, it can also be external to computer 1112. The hardware/software necessary for connection to the network interface 1148 includes, for exemplary purposes only, internal and external technologies such as, modems including regular telephone grade modems, cable modems and DSL modems, ISDN adapters, and Ethernet cards.

FIG. 12 is a schematic block diagram of a sample-computing environment 1200 that can be employed as part of a processing system of payment for downloaded digital content in accordance with an aspect of the subject innovation. The system 1200 includes one or more client(s) 1210. The client(s) 1210 can be hardware and/or software (e.g., threads, processes, computing devices). The system 1200 also includes one or more server(s) 1230. The server(s) 1230 can also be hardware and/or software (e.g., threads, processes, computing devices). The servers 1230 can house threads to perform transformations by employing the components described herein, for example. One possible communication between a client 1210 and a server 1230 may be in the form of a data packet adapted to be transmitted between two or more computer processes. The system 1200 includes a communication framework 1250 that can be employed to facilitate communications between the client(s) 1210 and the server(s) 1230. The client(s) 1210 are operatively connected to one or more client data store(s) 1260 that can be employed to store information local to the client(s) 1210. Similarly, the server(s) 1230 are operatively connected to one or more server data store(s) 1240 that can be employed to store information local to the servers 1230.

What has been described above includes various exemplary aspects. It is, of course, not possible to describe every conceivable combination of components or methodologies for purposes of describing these aspects, but one of ordinary skill in the art may recognize that many further combinations and permutations are possible. Accordingly, the aspects described herein are intended to embrace all such alterations, modifications and variations that fall within the spirit and scope of the appended claims.

Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer implemented system comprising:
a declaration component that identifies a data type(s) and enables users to define customized events; and
a procedural component that executes functions called by the customized events, the declaration component and the procedural component form a transformation component that transform the data type(s) to another type of data.

2. The computer implemented system of claim 1, the customized events include events of interests described by predicates.

3. The computer implemented system of claim 1 further comprising an API that advances through XML streams to insert results in appropriate tables of a relational data store.

4. The computer implemented system of claim 1, the data type(s) includes an XML stream that inserts results of transformation based on hierarchy of XML elements.

5. The computer implemented system of claim 1, the declaration component in form of a scheduling component to call events that satisfy configured predicates.

6. The computer implemented system of claim 5 further comprising an artificial intelligence component that facilitates adaptation of the procedural component.

7. The computer implemented system of claim 6, the events specify codes that are to be executed.

8. The computer implemented system of claim 6 further comprising a streaming interface that receives a data stream that includes the data type.

9. The computer implemented system of claim 6 individual transformations connect event handlers to events.

10. A computer implemented method comprising:
receiving a data type via a transformation component; and
transforming the data type via a hybrid of declarative features and procedural features.

11. The computer implemented method of claim 10 further comprising defining events by users as part of the declarative features.

12. The computer implemented method of claim 11 further comprising calling functions as part of the declarative features.

13. The computer implemented method of claim 12 further comprising performing mapping via user defined functions.

14. The computer implemented method of claim 13 further comprising calling functions for an element and inserting results to tables.

15. The computer implemented method of claim 14 further comprising adaptively training mapping functions.

16. The computer implemented method of claim 14 further comprising customizing programs of users to perform mapping transformations.

17. The computer implemented method of claim 14 further comprising implementing a new data structure as part of an output stream.

18. The computer implemented method of claim 17 further comprising indicating points to halt a data stream that is received by the transformation component.

19. The computer implemented method of claim 17 further comprising associating event handlers with events to specify codes to be executed.

20. A computer implemented system comprising:
means for receiving a data stream; and
means for transforming a data type of the data stream to another data type via procedural features and declarative features.
